(19) United States
(12) Patent Application Publication
(10) Pub. No.: US 2018/0129396 A1
(43) Pub. Date: May 10, 2018

(54) PROVIDING SHORTCUT ASSISTANCE FOR LAUNCHING APPLICATIONS

(71) Applicant: Google Inc., Mountain View, CA (US)

(72) Inventors: Thomas BUCKLEY, San Francisco, CA (US); Clara BAYARRI, London (GB); Ruqian ZHOU, Sunnyvale, CA (US)

(21) Appl. No.: 15/344,455

(22) Filed: Nov. 4, 2016

(51) Int. Cl. G06F 3/0481; G06F 3/0488; G06F 3/0482

(52) U.S. Cl. CPC G06F 3/04817; G06F 3/0482; G06F 3/04883

(57) ABSTRACT

Aspects of the subject technology relate to providing shortcut assistance. A graphical element and an associated identifier are displayed on a display device. The graphical element is associated with an application. A predetermined user input to display visual representations of shortcuts on the display device is received. In response to receiving the predetermined user input, a visual representation of a shortcut for the application is displayed. The shortcut, when performed, causes launching of the application.

### BACKGROUND

The present disclosure generally relates to shortcut assistance, and in particular, to providing shortcut assistance for launching applications.

Users may perform shortcuts (e.g., keyboard shortcuts, gestures) to execute actions corresponding to the performed shortcuts. Performance of a shortcut may replace more arduous and/or cumbersome task(s). For instance, in a word processing application, the keyboard shortcut Ctrl+A may be utilized to select all text in a given document. In contrast, without this keyboard shortcut, one way to select all text may be to go through a sequence of application menus in order to find/select a menu option that causes selection of all text. Once a user becomes more familiar with available shortcuts, such as shortcuts for an operating system or for an application, the user's efficiency and experience with respect to using the operating system or the application may be improved.

### SUMMARY

Aspects of the subject technology relate to a computer-implemented method. The method includes displaying, on a display device, one or more graphical elements and one or more associated identifiers. Each of the one or more graphical elements is associated with a respective application. The method further includes receiving a predetermined user input to display visual representations of shortcuts on the display device. The method further includes, in response to receiving the predetermined user input, displaying, on the display device, a visual representation of a respective shortcut for each respective application. The respective shortcut, when performed, causes launching of the respective application.

Aspects of the subject technology also relate to a computing system. The system includes one or more processors and a non-transitory machine-readable medium including instructions stored therein, which when executed by the one or more processors, cause the one or more processors to perform operations. The operations include receiving a first user input to display visual representations of shortcuts. The operations further include, in response to receiving the first user input, displaying a visual representation of a shortcut for a first application. The operations further include launching the first application when the shortcut for the first application is performed.

Aspects of the subject technology also relate to a non-transitory machine-readable medium including instructions stored therein, which when executed by a machine, cause the machine to perform operations. The operations include displaying, on a display device, a graphical element and an associated identifier. The graphical element is associated with an application. The operations further include receiving a first user input to display visual representations of shortcuts on the display device. The operations further include, in response to receiving the first user input, displaying, on the display device, a visual representation of a shortcut associated with the application. The visual representation obscures at least one of the graphical element or the associated identifier. The shortcut, when performed, causes launching of the application.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 illustrates an example network environment for facilitating providing shortcut assistance in accordance.

FIG. 2 illustrates an example sequence of user interfaces for providing shortcut assistance for launching applications, according to example aspects of the subject technology.

FIG. 3 shows a flowchart illustrating an example process for providing shortcut assistance for launching applications, according to example aspects of the subject technology.

FIG. 4 illustrates an example sequence of user interfaces for launching an application using a shortcut, according to example aspects of the subject technology.

FIG. 5 shows a flowchart illustrating an example process for launching an application using a shortcut, according to example aspects of the subject technology.

FIGS. 6A through 6E illustrate example user interfaces for providing shortcut assistance for launching an application using a shortcut, according to example aspects of the subject technology.

FIG. 7A illustrates an example user interface, according to example aspects of the subject technology.

FIGS. 7B and 7C illustrate example interfaces for providing shortcut assistance for global navigation, according to example aspects of the subject technology.

FIGS. 8A through 8C illustrate an example sequence of user interfaces for providing shortcut assistance, according to example aspects of the subject technology.

FIG. 8D illustrates an example user interface for providing shortcut assistance, according to example aspects of the subject technology.

FIG. 9A illustrates an example sequence of user interfaces for providing shortcut assistance of application level shortcuts, according to example aspects of the subject technology.

FIG. 9B illustrates an example user interface for performing a search of shortcuts, according to example aspects of the subject technology.

FIG. 9C illustrates an example user interface that includes a button for closing shortcut assistance, according to example aspects of the subject technology.

FIG. 9D illustrates an example user interface that includes a button for displaying visual representations of more shortcuts, according to example aspects of the subject technology.

FIG. 10 illustrates an example user interface for providing shortcut assistance, according to example aspects of the subject technology.

FIG. 11A illustrates an example user interface including multiple application windows, according to example aspects of the subject technology.

FIGS. 11B through 11E illustrates example user interfaces for displaying shortcuts in a shortcut assistance overlay interface when multiple application windows are displayed, according to example aspects of the subject technology

FIG. 12 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

The subject systems and methods provide shortcut assistance to a user. A shortcut may include a keyboard shortcut and/or a gesture (e.g., performed on a touchscreen) that a user can perform in order to cause execution of an action corresponding to the performed shortcut. The keyboard shortcut may involve a key input or a combination of key inputs performed, for example, on a virtual keyboard or a physical keyboard. Examples of actions executed upon performing a shortcut may include launching an application, copying selected text, pasting previously selected text, etc.

The shortcut assistance may provide the user with visual representations of available shortcuts that indicate the key input(s) and/or gesture(s) involved in the shortcuts. By way of non-limiting example, the shortcuts may include application launching shortcuts; system level shortcuts, such as shortcuts associated with an operating system (OS); and/or application level shortcuts, such as shortcuts associated with actions within an application (e.g., word processing application, email application, etc.) running on the OS. In general, the shortcut assistance may be utilized as an educational layer to inform the user of available shortcuts, thus facilitating improved efficiency and experience of the user as the user becomes more familiar with the available shortcuts.

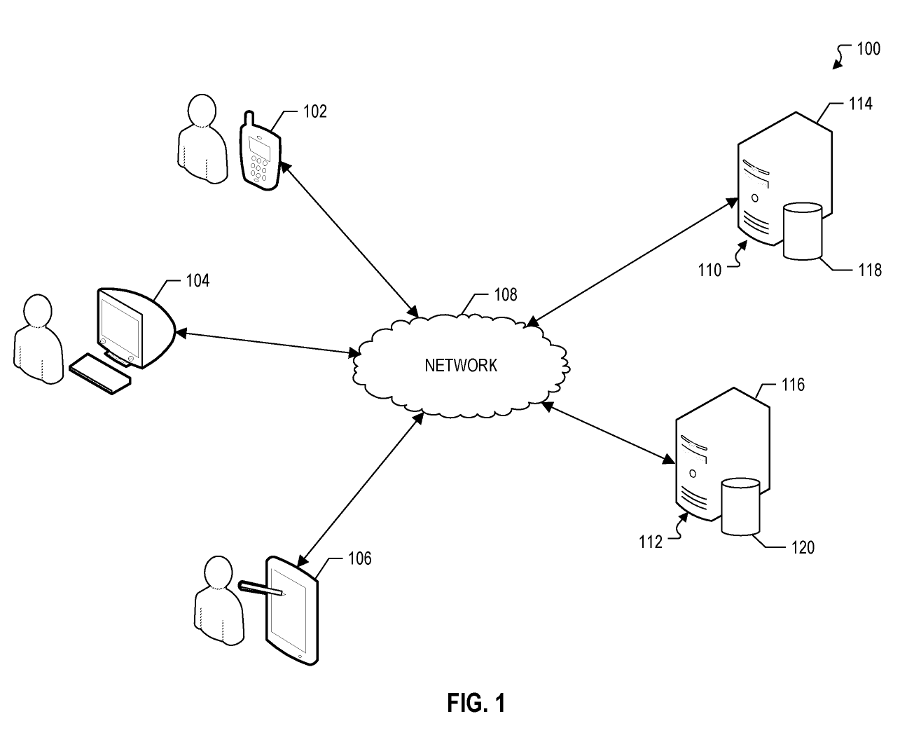

FIG. 1 illustrates an example network environment 100 for facilitating providing shortcut assistance in accordance with the subject technology. The network environment 100 includes computing devices 102, 104, and 106 (hereafter “102-106”) and computing systems 110 and 112 (hereafter “110-112”). The computing devices 102-106 and computing systems 110-112 can communicate with each other through a network 108. Each of the computing systems 110-112 can include one or more servers 114 and 116 and one or more data stores 118 and 120. In some aspects, the network environment 100 can have more or fewer computing devices (e.g., 102-106) and/or computing systems (e.g., 110-112) than those shown in FIG. 1.

Each of the computing devices 102-106 can represent various forms of processing devices that have a processor, a memory, and communications capability. The computing devices 102-106 may communicate with each other, with the computing systems 110-112, and/or with other systems and devices not shown in FIG. 1. By way of non-limiting example, processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any of these processing devices or other processing devices.

Any of the computing devices 102-106 may execute computer instructions to run applications (e.g., applications installed on the computing devices 102-106), including an OS and applications compatible with the OS (e.g., a web browser application, an email application, a social networking application, etc.), and to provide for display user interfaces associated with these applications. The applications may include web applications (e.g., an email application) that involve the computing devices 102-106 accessing and/or retrieving data (e.g., emails, instructions to run the email application, shortcuts) stored remotely, and/or non-web-based applications that need not involve web access. For example, any of the computing devices 102-106 may execute computer instructions to run a web application hosted by the computing system 110.

In example aspects, any of the computing devices 102-106 may trigger shortcut assistance to cause visual representations of available shortcuts associated with the applications to be displayed. The visual representations of the shortcuts may indicate the key input(s) and/or gesture(s) involved in the shortcuts. Any of the computing devices 102-106 may receive user input (e.g., keyboard input, touch input), determine whether the received user input matches a shortcut associated with an application, and, if a match is found, effectuate an action associated with the shortcut. The visual representations of the available shortcuts may be displayed on a respective display device (e.g., screen, monitor) associated with the computing devices 102-106. In some aspects, any of the computing devices 102-106 may be associated with multiple display devices.

The computing devices 102-106 may locally store the available shortcuts for an application (e.g., in a file associated with the application). For a given application, the available shortcuts associated with the application may include shortcuts (e.g., factory-set shortcuts, default shortcuts) defined by a creator, author, owner, distributor, etc., of the application, shortcuts (e.g., customized shortcuts) defined by a user of the application, etc. Some applications may allow a user to adjust existing shortcuts and/or define new shortcuts for the applications. In some cases, the computing devices 102-106 may locally store default shortcuts along with shortcuts as customized (e.g., adjusted and/or defined) by the user, such that the default shortcuts may be restored at a later time.

Each of the computing systems 110-112 may be any system or device having a processor, a memory, and communications capability. In some example aspects, any of the computing systems 110-112 can be a single server (e.g., 114). In other implementations, any of the computing systems 110-112 can represent more than one computing device working together to perform the actions of a computer server (e.g., cluster of machines). Further, any of the computing systems 110-112 can represent various forms of servers including, but not limited to, a web server, an application server, a proxy server, a network server, or a server farm.

In example aspects, the computing system 110 may execute computer instructions to host a website accessible to the computing devices 102-106. In some cases, the computing system 110 may host a web application(s) (e.g., a game application, an email application, a social networking application) on the website. For a given web application hosted by the computing system 110, the computing devices 102-106 may access the web application by logging into an online account created for the web application. Being logged into the online account may allow the computing devices 102-106 to access some or all features of the web application. For example, the web application may have multiple account types, with each account type allowing access to an associated set of features. The web application may allow access to at least some features without being logged into an online account. In other cases, the web application does not have an account creation process. In some aspects, the computing system 110 can include one or more servers 114, where use of more than one server may facilitate load balancing between the servers (e.g., to allow many computing devices to simultaneously run the web application(s) from the servers).

The computing system 110 may store shortcuts associated with the web application. The available shortcuts associated with the web application may include shortcuts (e.g., factory-set shortcuts, default shortcuts) defined by a creator, author, owner, distributor, etc., of the web application, shortcuts (e.g., customized shortcuts) defined by a user for the web application and stored in associated with the user's online account, etc. The shortcuts stored by the computing system 110 may be retrieved by the computing devices 102-106 as a list of shortcuts (e.g., contained in a file) for example. In some cases, the list of shortcuts may include shortcut groupings and shortcuts associated with each shortcut grouping. The shortcuts may be grouped based on frequency (e.g., expected frequency) of use of the shortcuts and/or actions associated with the shortcuts. The shortcut groupings may be defined by a creator, author, owner, and/or distributor of the web application, among others who may provide the website, and/or users of the web application. For example, in an email application, the shortcuts may be grouped into a “Common” shortcut group, which includes shortcuts commonly used by users of the email application and/or shortcuts associated with actions that are commonly performed by the users, and a “Compose” shortcut group, which includes shortcuts associated with emails transmitted and received via the email application. In some cases, shortcuts may be included in more than one shortcut grouping.

In some cases, the website hosted by the computing system 110 may provide (e.g., via links on one or more web pages) information associated with an application(s) (e.g., web application, non-web-based application) and/or its associated plug-in(s) by the computing devices 102-106. For example, the website may provide support for the application(s), such as by providing information on how to buy, download, install, and/or use the application(s), providing customer service, providing the application(s) for download, etc. The website may be, but need not be, associated with (e.g., maintained and/or owned by), for example, a creator, author, owner, and/or distributor of the applications, among others who may provide the website. In some aspects, the computing system 110 can include one or more servers 114, where use of more than one server may facilitate load balancing between the servers (e.g., to allow many computing devices to simultaneously request/download one or more applications from the servers).

In example aspects, the computing system 112 may execute computer instructions to facilitate providing shortcut assistance. The computing system 112 may be associated with an online service, such as an email service and/or a social network service, among other online services. When a user creates an online account for the online service, the computing system 112 may allow the user to store preferences associated with shortcut assistance on the computing system 112 (e.g., the data store 120) and/or on a computing system (not shown) associated with the online service. The user preferences associated with shortcut assistance may include, for example, user settings for how to trigger the shortcut assistance, user settings for which shortcuts to display, user settings for how to display the visual representations of the shortcuts to the user, adjustments made by the user to default shortcuts associated with the applications, and/or new shortcuts defined by the user for the applications, among others. In some cases, the user may set different preferences for different applications.

The computing system 112 may also allow synchronization of the user preferences with computing devices (e.g., smartphones, tablets, desktop computers) that are designated by the user and/or computing systems associated with the online service that are designated by the user. Synchronization of the user preferences stored on the computing device 102 with those stored on the computing system 112 may be initiated when the user logs into the online account using the computing device 102. Synchronization of the user preferences stored on other computing devices designated to allow synchronization by the user with those stored on the computing system 112 may also be initiated when the user logs into the online account using these other computing devices. The users may be provided with options to allow the users to set whether or not to synchronize the user preferences stored in a computing device of the user (e.g., the computing device 102) with the computing system 112 and/or other computing devices and computing systems.

In some aspects, the computing devices, including 102-106, and computing systems, including 110-112, may communicate wirelessly through a communication interface (not shown), which may include digital signal processing circuitry where necessary. For example, a computing device (e.g., 102) may communicate with another computing device (e.g., 104) and/or a computing system (e.g., 110), and a computing system (e.g., 110) may communicate with another computing system (e.g., 112) and/or a computing device (e.g., 102). The communication interface may provide for communications under various modes or protocols, for example, Global System for Mobile (GSM) communication voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver.

In some aspects, the network environment 100 can be a distributed client/server system that spans one or more networks such as, for example, the network 108. The network 108 can be a large computer network such as, for example, a local area network (LAN), wide area network (WAN), the Internet, a cellular network, or a combination thereof connecting any number of mobile clients, fixed clients, and servers. Further, the network 108 can include, but is not limited to, any one or more of the following network topologies, including a bus network, a star network, a ring network, a mesh network, a star-bus network, a tree or hierarchical network, and the like. In some aspects, communication between each client (e.g., computing devices 102-106) and server (e.g., computing systems 110-112) can occur via a virtual private network (VPN), Secure Shell (SSH) tunnel, or other secure network connection. In some aspects, the network 108 may further include a corporate network (e.g., intranet) and one or more wireless access points.

In situations in which the systems discussed here collect personal information about users, or may make use of personal information, the users may be provided with an opportunity to control whether programs or features collect user information (e.g., information about a user's preferences for shortcut assistance, shortcuts performed by a user, or a user's location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, zip code, or state level), so that a particular location of a user cannot be determined. Thus, the user may have control over how information is collected about the user and used.

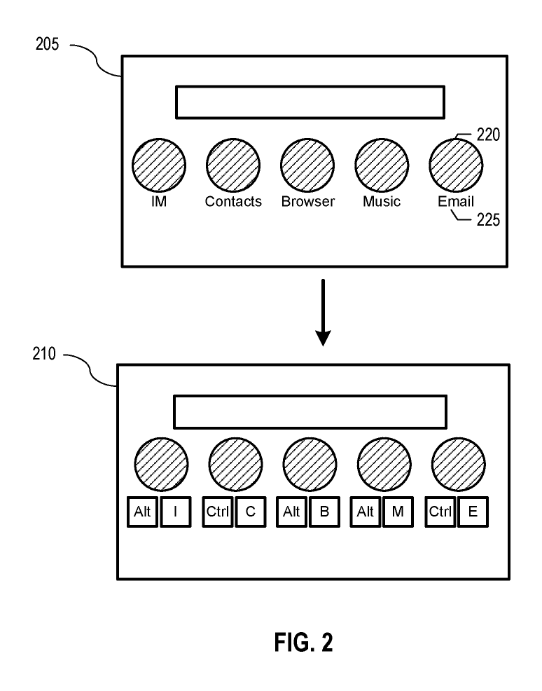

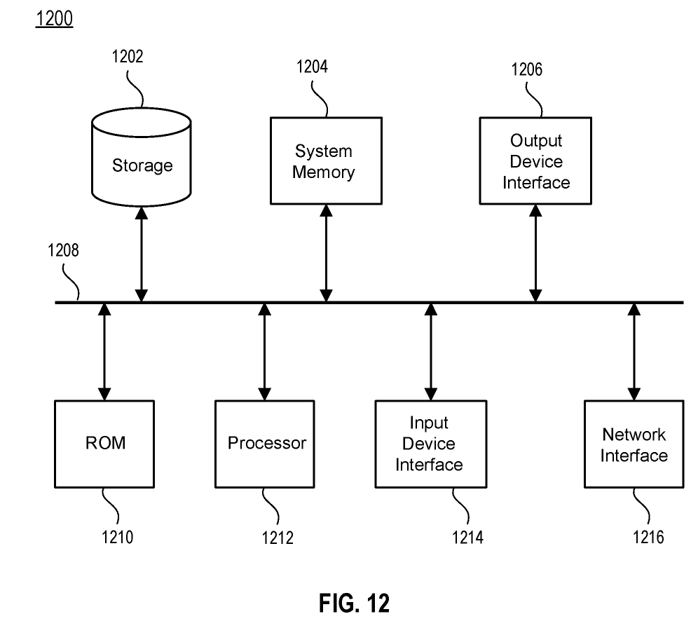

It is noted that user interfaces illustrated in each of FIGS. 2, 4, 6A-6E, 7A-7C, 8A, 8B, 9A-9D, 10, and 11A-11E may, but need not, cover an entirety of a display device (e.g., screen, touchscreen, monitor) connected to or otherwise associated with a computing device (e.g., any one of computing devices 102-106 of FIG. 1). An example of the computing device and/or the display device is the electronic system 1200 described with respect to FIG. 12.

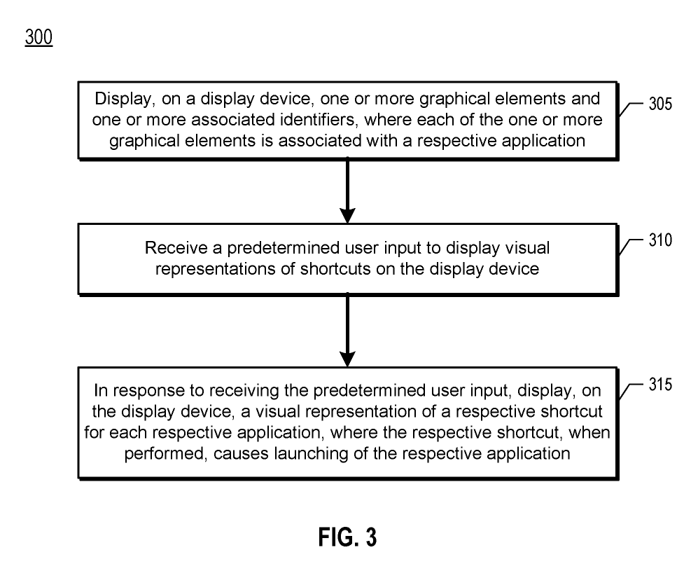

FIG. 2 illustrates an example sequence of user interfaces 205 and 210 for providing shortcut assistance for launching applications, according to example aspects of the subject technology. The user interfaces 205 and 210 may be provided in a home screen, application selection screen, and so forth, associated with an OS running on the computing device (e.g., 102 of FIG. 1) for example. FIG. 2 will be discussed with reference to FIG. 3. FIG. 3 shows a flowchart illustrating an example process 300 for providing shortcut assistance for launching applications, according to example aspects of the subject technology.

At block 305, the user interface 205 is displayed on the display device. The user interface 205 includes graphical elements (e.g., 220) and a respective identifier (e.g., 225) for each of the graphical elements. Each of the graphical elements and identifiers are associated with a respective application. In this regard, the user interface 205 includes five graphical elements and their respective identifiers that correspond to, from left to right, an instant messaging application, a contacts (e.g., phone book) and dialer application, a browser application, a music (e.g., music player) application, and an email application. The graphical element that has the identifier “IM” is associated with the instant messaging application, the graphical element that has the identifier “Browser” is associated with the browser application, and so forth. For example, in FIG. 2, the user interface 205 includes the graphical element 220 and its associated identifier 225 (“Email”), which are associated with the email application. The graphical elements, when selected (e.g., tapped), may cause launching of the corresponding applications.

Although the graphical elements are identical to each other in FIG. 2, the graphical elements for different applications may be different in other implementations. The identifiers and/or the graphical elements may help the user identify the associated applications. In some cases, the identifiers may provide textual information for identifying the associated applications whereas the graphical elements may provide graphical and/or textual information for identifying the associated applications. The identifier may be an application name for example. By way of non-limiting example, the graphical elements of different applications may have different colors, sizes, shapes, or combinations thereof, among others. For instance, the graphical element for the contacts and dialer application may take on the appearance of a phone book. The graphical elements and/or identifiers utilized for different applications may be pre-set, such as by a creator, author, owner, distributor, etc., of the application for example. In an aspect, the user may subsequently customize these existing settings. For instance, the user may change the graphical element and/or identifier associated with the application.

At block 310, a predetermined user input for shortcut assistance is received by the computing device. For example, the predetermined user input for triggering the shortcut assistance may include pressing and holding a predetermined key (e.g., Meta key) for a predetermined amount of time (e.g., 5 seconds), pressing a predetermined combination of keys, selecting a menu option that triggers the shortcut assistance, etc. The predetermined user input may be received via a physical keyboard communicatively connected with the computing device. In some implementations, other entry points for triggering shortcut assistance may be provided. The shortcut assistance may be launched by selecting an associated menu option in a help application (e.g., provided by the OS), a settings menu, a help menu within an application, etc. In some cases, the user may adjust existing actions and/or define new actions for triggering the shortcut assistance.

At block 315, upon receiving, by the computing device, the predetermined user input for shortcut assistance, the display device may transition from displaying the user interface 205 to displaying the user interface 210. To provide shortcut assistance, a visual representation of a respective shortcut for each graphical element associated with a respective application may be displayed, where the respective shortcut, when performed, causes launching of the associated application. To transition from displaying the user interface 205 to displaying the user interface 210, the computing device may retrieve the shortcuts, generate the visual representations of the retrieved shortcuts, and provide the generated visual representations for display by the display device (e.g., in a pre-set or user-defined manner). The shortcuts may be retrieved from local storage of the computing device and/or retrieved from remote storage (e.g., from the computing systems 110 and/or 112). For instance, the shortcuts may be retrieved as a list of shortcuts (e.g., contained in a file). In some cases, the computing device may retrieve the shortcuts from remote storage prior to receiving any predetermined user input for shortcut assistance.

As shown in the user interface 210, each identifier associated with an application is replaced with a respective visual representation of a respective shortcut for launching the application. For instance, the identifier “Browser” associated with the browser application is replaced with the visual representation of the shortcut for launching the browser application. In FIG. 2, the visual representation of the shortcut includes a first box containing the letters “Alt” and a second box containing the letter “B”. The visual representation of the shortcut indicates that, to launch the browser application, the user can perform the shortcut Alt+B, which may involve pressing and holding (e.g., on a physical keyboard) the Alt key, pressing the B key while the Alt key is still being held, and then releasing both keys. The shortcuts associated with the different applications may be pre-set. In an aspect, the user may subsequently customize these existing shortcuts and/or define new shortcuts (e.g., for applications not pre-set with shortcuts).

A predetermined user input may be defined for closing the shortcut assistance (e.g., transitioning from the user interface 210 to the user interface 205). For example, the predetermined user input for closing the shortcut assistance may include pressing a predetermined key (e.g., Meta key, Esc key), pressing a predetermined key for a predetermined amount of time, pressing a predetermined combination of keys, selecting a menu option that closes the shortcut assistance, selecting (e.g., tapping, clicking on a mouse) whitespace on the display device, etc. The predetermined user input may be received via a physical keyboard communicatively connected with the computing device. The user may adjust existing actions and/or define new actions for closing the shortcut assistance.

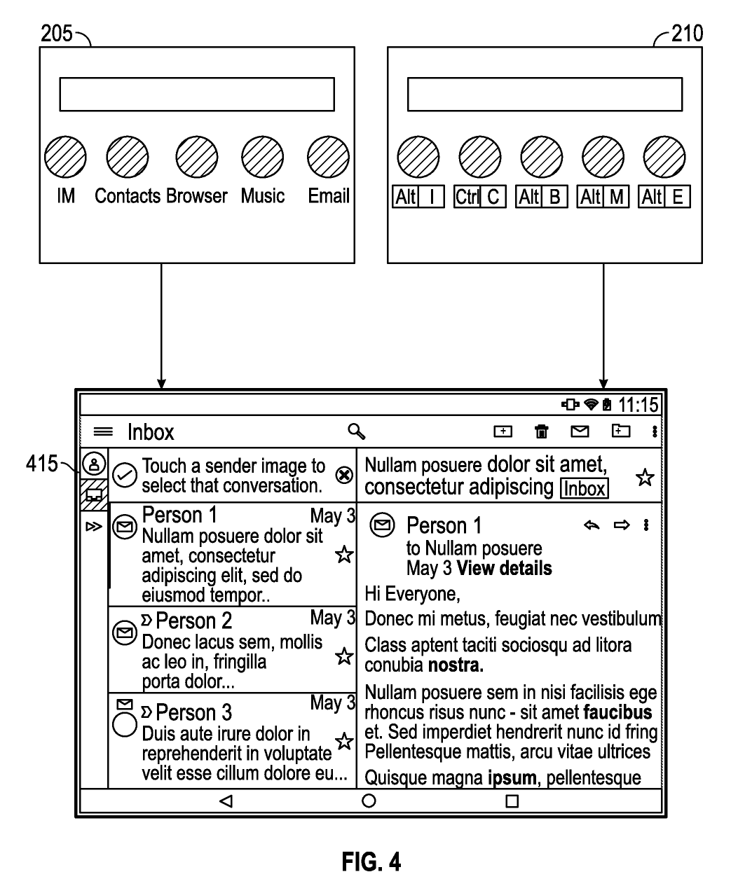

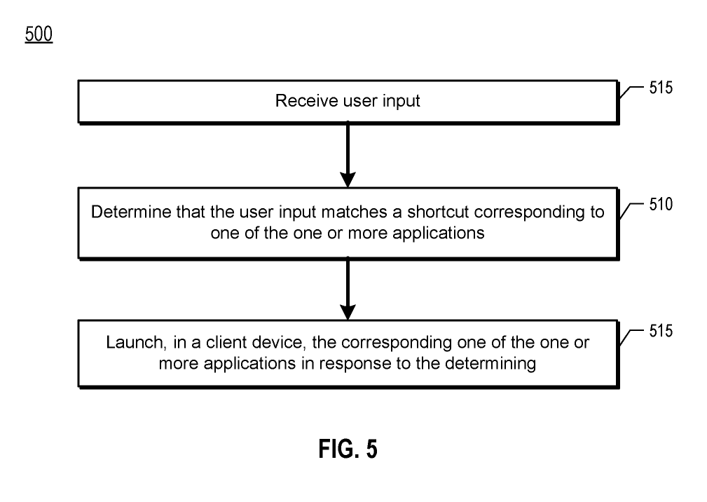

FIG. 4 illustrates an example sequence of user interfaces 205, 210, and 415 for launching an application using a shortcut, according to example aspects of the subject technology. FIG. 4 will be discussed with reference to FIG. 5. FIG. 5 shows a flowchart illustrating an example process 500 for launching an application using a shortcut, according to example aspects of the subject technology.

At block 505, a user input is received by the computing device. In some cases, the user input may be received when the user interface 205 is displayed on the display device (e.g., the shortcuts associated with the applications are not displayed). In other cases, the user input may be received when the user interface 210 is displayed on the display device (e.g., the shortcuts associated with the applications are displayed). In these latter cases, the process 500 may be performed after the process 300 of FIG. 3 is performed, for example.

At block 510, the user input that is received is determined to match a shortcut corresponding to an application. To determine whether a match occurs, the computing device may compare the user input (e.g., key or key combination, gesture, etc.) to a list of available shortcuts, for example. The list of available shortcuts may include shortcuts that, when performed, cause the corresponding applications to be launched in the computing device. The list of available shortcuts may include default shortcuts and customized shortcuts (e.g., shortcuts adjusted or defined by the user). The list of available shortcuts may be stored locally at the computing device and/or remotely (e.g., at the computing systems 110 and/or 112). In some cases, as shown in FIG. 4, the user input may match a shortcut for an application whose visual representation of the shortcut is displayed on the display device (e.g., the email application) when the user input is received. In other cases, the user input may match a shortcut for an application whose visual representation of the shortcut is not displayed on the display device when the user input is received.

At block 515, the application corresponding to the shortcut that matches the user input is launched in the computing device. For instance, in FIG. 4, the user input that is received is Ctrl+E, which causes the computing device to launch the email application associated with the Ctrl+E shortcut. In this regard, the display device may transition from displaying the user interface 205 to displaying the user interface 415 or from displaying the user interface 210 to displaying the user interface 415. The user interface 415 includes an email application window opened in the computing device and displayed on the display device.

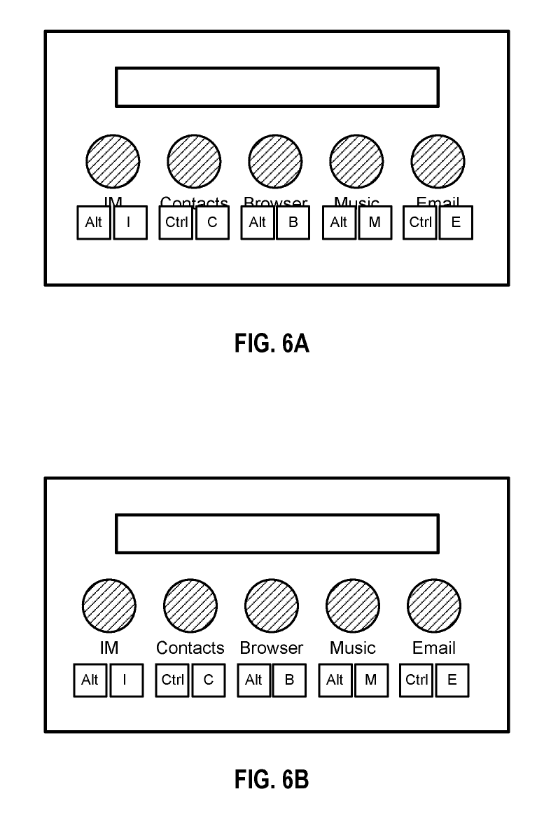

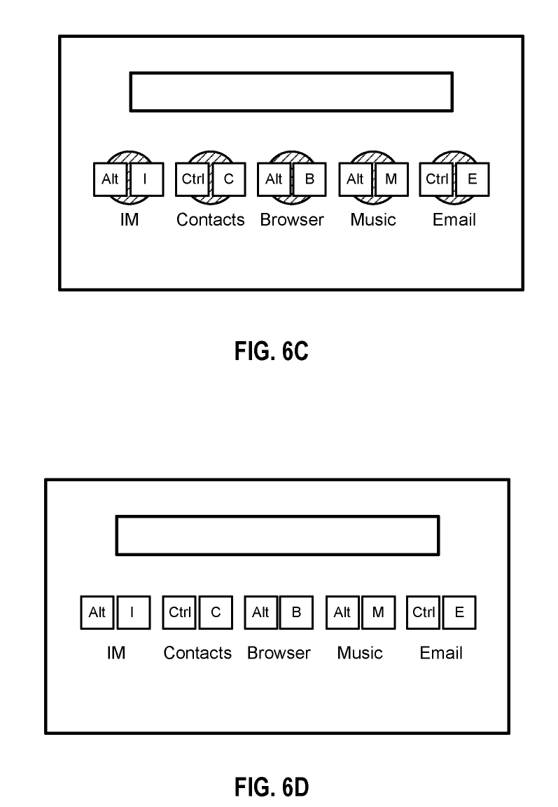

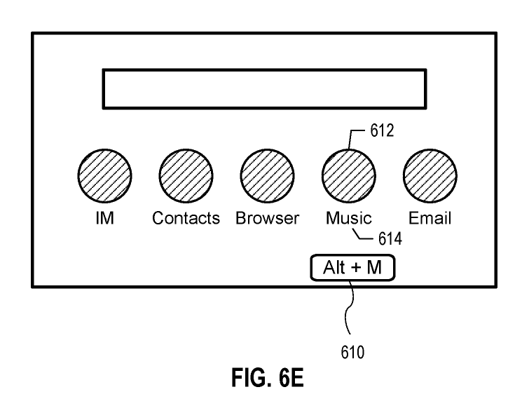

Other possibilities may be utilized for displaying the shortcuts to the user. For example, FIGS. 6A, 6B, 6C, 6D, and 6E illustrate example user interfaces for providing shortcut assistance for launching an application using a shortcut, according to example aspects of the subject technology. In one example, as shown in FIGS. 6A and 6B, rather than replacing the identifier with the visual representation of the shortcut for the application, the visual representation of the shortcut can be displayed alongside the identifier. In this regard, in FIG. 6A, the visual representations of the shortcuts obscure a portion of the identifier. In FIG. 6B, the visual representations of the shortcuts do not obscure the identifier. In another example, as shown in FIGS. 6C and 6D, the identifier associated with the application may be left intact while the graphical element of the application may be obscured or replaced by the visual representation of the shortcut. In FIG. 6C, the graphical elements are obscured by the visual representations of the shortcuts. In FIG. 6D, the graphical elements are replaced by the visual representations of the shortcuts.

The shortcuts for the applications may be indicated to the user (e.g., in a pop-up notification) based on interaction with the graphical elements and/or the identifiers. In FIG. 6E, a pop-up notification 610 that contains a visual representation of the shortcut for launching the email application is displayed to the user based on interaction with a graphical element 612 and/or an identifier 614 associated with the email application. An example interaction may include a long-press on the graphical element 612 and/or the identifier 614, hovering a mouse/trackpad cursor over the graphical element 612 and/or the identifier 614, among others.

Other possibilities may be utilized for displaying the shortcuts to the user. For instance, the visual representation of the shortcuts may obscure at least a portion of the graphical elements and the identifiers. In some cases, a manner by which to display the visual representations of the shortcuts may be based on an amount of real estate on the display device; a size and/or shape associated with the graphical elements and/or identifiers; complexity (e.g., number of keys) of the shortcuts, user preferences, etc. With regard to user preferences, in some cases, the user may be provided with options that allow the user to select the manner by which the user would like to be presented with the shortcuts.

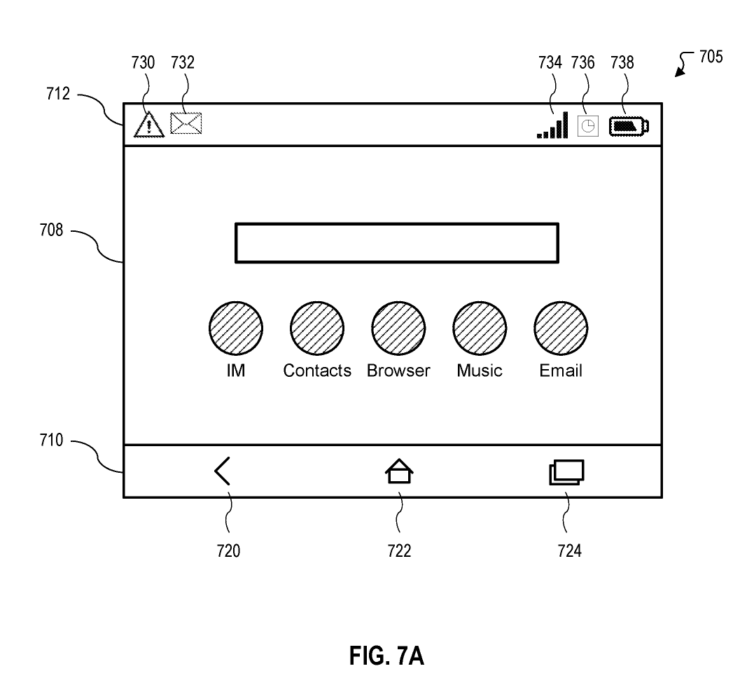

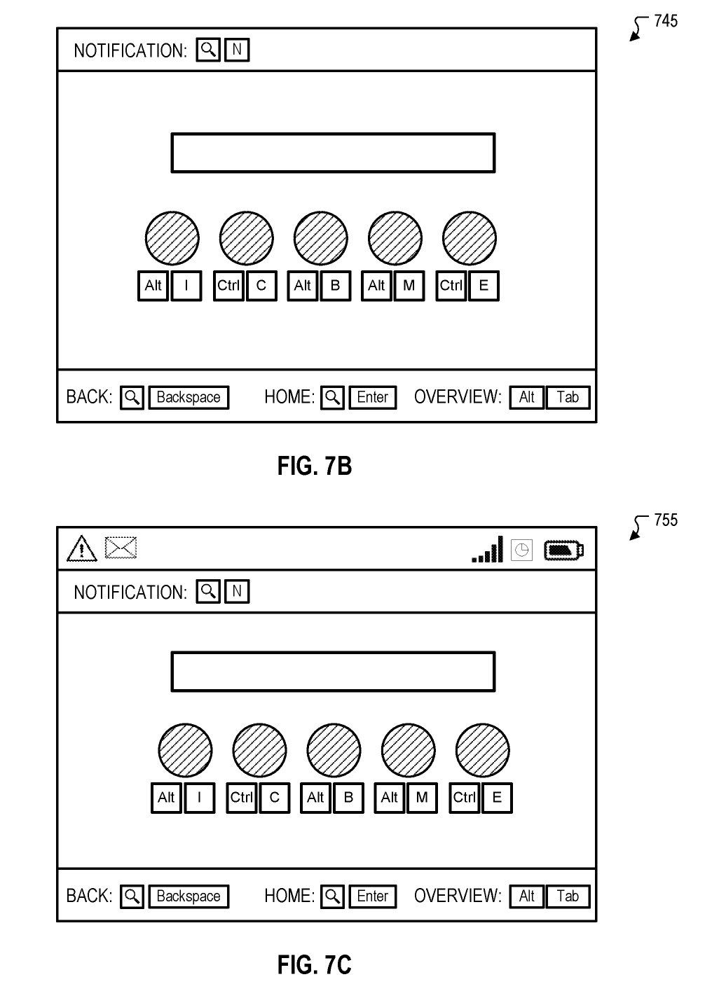

FIG. 7A illustrates an example user interface 705, according to example aspects of the subject technology. The user interface 705 may be provided in a home screen, for example. The user interface 705 includes a display area 708, a navigation bar 710, and a notification bar 712. In FIG. 7A, the display area 708 shows graphical elements and identifiers associated with applications. The graphical elements and identifiers may correspond to those described with respect to FIG. 2. In some cases, an application window(s) may be displayed in the display area 708.

The navigation bar 710 may include graphical elements 720, 722, and 724 for facilitating navigation. The graphical element 720, when pressed, may cause different actions depending on which application is the focused application. In some cases, an application is a focused application when its application window is currently selected and is displayed as being in front of all other application windows. The focused application receives input (e.g., keyboard input, gesture input, shortcut input, etc.) from the user. A focused application may also be referred to as an active application. For example, if a web browser application is the focused application, the graphical element 720, when pressed, may cause navigation from a currently visited web page to a web page visited immediately prior to the currently visited web page. If there is no web page that was visited immediately prior to the currently visited web page, cause closing of the web browser application and/or returning to a previously opened application. The graphical element 722, when pressed, may cause navigation to the home screen. In some cases, when the home screen is displayed in the display device, the graphical elements 720 and 722, when pressed, do not cause visible changes to the user interface displayed in the display device. The graphical element 724, when pressed, may cause display of a view in which the user may scroll through a listing of opened applications in order to close an opened application and/or select an opened application as the focused application.

In some cases, the navigation bar 710 may remain displayed independent of the content displayed in the display area 708. In this regard, since the navigation bar 710 may be accessible (e.g., globally accessible) to the user independent of which applications are open and/or which application is focused, navigation facilitated by the navigation bar 710 may be referred to as global navigation.

The notification bar 712 may include graphical elements (e.g., 730, 732, 734, 736, 738) that provide notifications to the user. By way of non-limiting example, a notification may provide a status associated with the computing device, a status associated with an application running on the computing device, a status of a file download or upload, among others. For example, in FIG. 7A, the notification bar 712 may include a graphical element 730 that indicates a problem with an account login, a graphical element 732 associated with an email application that indicates presence of received emails not yet opened by the user, a graphical element 734 that indicates a network signal strength, a graphical element 736 that indicates an active alarm clock, and a graphical element 738 that indicates whether or not the computing device's battery is being charged and/or an amount (e.g., percentage) of battery power remaining in the computing device's battery.

The OS may allow the user to view a list of notifications by performing a downward swipe gesture starting from a top of the user interface 705. In some aspects, some notifications on the list have an associated graphical element in the notification bar 712, some notifications on the list do not have an associated graphical element in the notification bar 712, and/or some notifications in the notification bar 712 may not be on the list. In some cases, the notification bar 712 may remain displayed independent of the content displayed in the display area 708, and the list of notifications may be accessible to the user independent of which applications are open and/or which application is focused.

FIG. 7B illustrates an example interface 745 for providing shortcut assistance for global navigation, according to example aspects of the subject technology. The display device may transition from displaying the user interface 705 to displaying the user interface 745 upon receiving, by the computing device, a predetermined user input for shortcut assistance. With respect to FIGS. 7A and 7B, the graphical elements 720, 722, and 724 are replaced with visual representations of the associated shortcuts. For example, the graphical element 722 is replaced with a visual representation of the shortcut for returning to the home screen. With respect to FIGS. 7A and 7B, the notification bar 712 is replaced with a visual representation of the shortcut for displaying the list of notifications.

FIG. 7C illustrates an example interface 755 for providing shortcut assistance for global navigation, according to example aspects of the subject technology. The display device may transition from displaying the user interface 705 to displaying the user interface 755 upon receiving, by the computing device, a predetermined user input for shortcut assistance. In FIG. 7C, the notification bar 712 is displayed concurrently with the visual representation of the shortcut for displaying the list of notifications.

In FIGS. 7B and 7C, the visual representations of the shortcuts for global navigation and those for launching applications are concurrently displayed. In some cases, the predetermined user input for triggering shortcut assistance for global navigation may be the same, or may be different, from the predetermined user input for triggering shortcut assistance for launching applications (e.g., described above with respect to FIG. 2). In some cases, a different predetermined user input may be defined to cause display of visual representations of shortcuts for global navigation only, launching applications only, and both global navigation and launching applications.

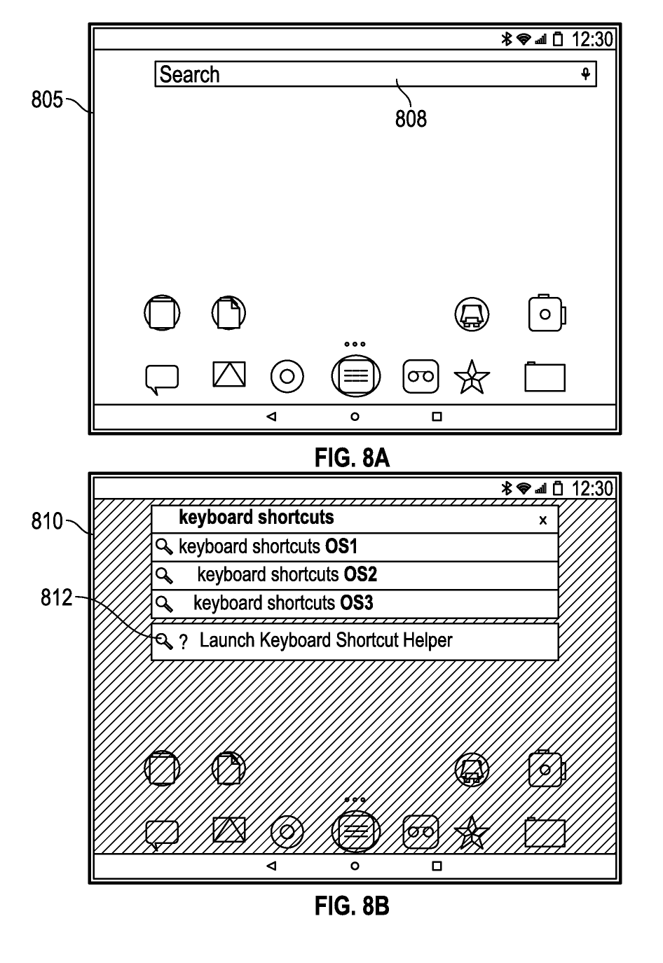

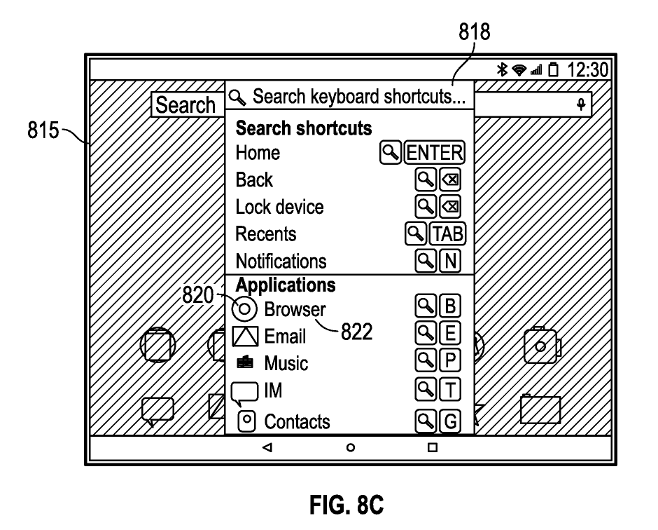

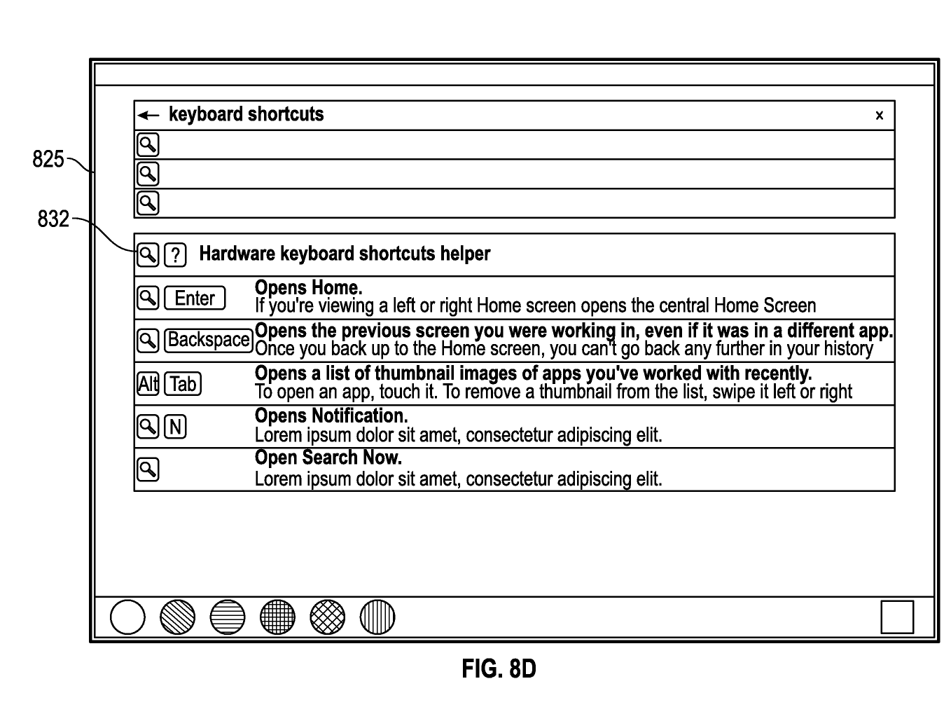

FIGS. 8A through 8C illustrate an example sequence of user interfaces 805, 810, and 815 for providing shortcut assistance, according to example aspects of the subject technology. The user interface 805 in FIG. 8A may be provided in a home screen, application selection screen, and so forth, associated with an OS running on the computing device. The user interface 805 includes a search bar 808, which can be utilized to accept search terms from the user (e.g., via a virtual or physical keyboard). The shortcut assistance may be accessed through user interaction with the search bar 808.

The search terms provided in the search bar 808 may cause generation of search results listing associated files and/or applications stored in or otherwise accessible by the computing device. The user may select a search result entry to open an associated file or application, for example. In some implementations, the search bar 808 may be associated with a browser application such that the search terms provided in the search bar 808 may be provided as search terms for a search engine accessed through the browser application.

In the user interface 810 in FIG. 8B, the search terms “keyboard shortcuts” are provided in (e.g., typed into) the search bar 808 by the user. Search suggestions may be generated based on the search terms provided by the user. In some cases, search suggestions are provided (and possibly adjusted) as the search terms are being typed. A search result entry 812 for providing shortcut assistance may be provided in response to the search terms being provided. Other search terms that include a subset of terms, superset of terms, and/or terms with similar meaning to “keyboard shortcuts” may also cause the search result entry 812, which recites “Launch Keyboard Shortcut Helper”, to be generated.

When the entry 812 is selected, the display device may transition from displaying the user interface 810 to displaying the user interface 815. In the user interface 815 in FIG. 8C, a shortcut assistance overlay interface 818 may be displayed that provides a visual representation of system shortcuts (e.g., shortcuts associated with an OS) and application launching shortcuts. Displaying of the shortcut assistance overlay interface 818 may be referred to as launching shortcut assistance or triggering shortcut assistance. The system shortcuts may include global navigation shortcuts. As shown in the user interface 815, the shortcuts may be grouped into system shortcuts and application launching shortcuts, with a respective group heading provided for each group of shortcuts. A graphical element and/or an identifier may be provided with the visual representation of each shortcut in the shortcut assistance overlay interface 818.

The shortcut assistance overlay interface 818 may be displayed on top of any user interface components (e.g., graphical elements, identifiers, application windows) currently displayed in the display device. For instance, in FIGS. 8A through 8C, the shortcut assistance overlay interface 818 is displayed on top of graphical elements, identifiers, and the search bar 808. In some implementations, alternative or in addition to displaying the shortcut assistance overlay interface 818 via interaction with the search bar 808, the shortcut assistance overlay interface 818 may be displayed in response to a predetermined user input (e.g., pressing and holding the Meta key for 3 seconds) provided to the computing device.

In some implementations, the user may need to dismiss (e.g., close) the shortcut assistance overlay interface 818 (e.g., by pressing the Esc key) and perform the shortcut in order to effectuate the shortcut. In other implementations, the user may perform and effectuate the shortcut when the shortcut assistance overlay interface 818 is still displayed, and the shortcut assistance overlay interface 818 may close in response to the shortcut being performed.

In some cases, shortcuts and/or shortcut groupings displayed in the shortcut assistance overlay interface 818, and/or order in which to display the shortcuts and/or shortcut groupings, may be selected by the OS (e.g., developer, distributor, etc., of the OS), application (e.g., creator, author, owner, distributor, etc., of the application), and/or the user. For example, the application may set a default shortcut to be used for launching the application, a default graphical element (e.g., 820), and/or a default identifier (e.g., 822), each of which may be customizable by a user. The graphical element and identifier displayed in the shortcut assistance overlay interface 818 may be the same as the graphical element and identifier displayed in the home screen, application selection screen, etc.

In some aspects, the shortcut assistance overlay interface 818 displays only a subset of available shortcuts and/or shortcut groupings. The available shortcuts whose visual representation are displayed and/or shortcut groupings displayed in the shortcut assistance overlay interface 818 may be those shortcuts and shortcut groups associated with actions determined to be most commonly used (e.g., by the user of the computing device, users of the OS, and/or users of the applications). Similarly, in some aspects, the OS may set an order in which to display the shortcut groupings and the shortcuts for each shortcut grouping. The order may be based on how frequently users of the OS and/or users of the applications use the applications and/or perform actions associated with the shortcuts (e.g., with or without using the shortcuts). For instance, the OS may determine that the system shortcut for returning to the home screen (denoted as “Home” in FIG. 8C) is the most commonly used system shortcut and display the visual representation of the associated system shortcut as the first shortcut under the shortcut grouping (denoted as “Search Shortcuts” in FIG. 8C). In some cases, the user may be provided with options that allow the user to adjust (e.g., change, add, remove) the shortcut groupings and/or shortcuts associated with each shortcut grouping.

In some implementations, the shortcut assistance overlay interface 818 provides a common interface within which visual representations of system shortcuts, application launching shortcuts, and/or application level shortcuts (e.g., shortcuts associated with actions within applications) may be displayed. For example, a size and shape of the shortcut assistance overlay interface 818 and a font size and font color of text, size of graphical elements, color of group headings for system shortcuts, color of group headings for application launching shortcuts, etc. displayed in the shortcut assistance overlay interface 818 may be set for the shortcut assistance overlay interface 818 and independent of the application within which the shortcut assistance is launched. In some cases, the size and shape of the shortcut assistance overlay interface 818 and content displayed in the shortcut assistance overlay interface 818 may be set based on an amount of real estate on the display device and/or may be customizable by a user.

FIG. 8D illustrates an example user interface 825 for providing shortcut assistance, according to example aspects of the subject technology. In FIG. 8D, a search result entry 832 for providing shortcut assistance is displayed together with visual representations of shortcuts (e.g., system level shortcuts). Additionally, in FIG. 8D, the search result entry 832 itself is associated with a shortcut. When the search result entry 832 is selected, the display device may display the shortcut assistance overlay interface 818 shown in FIG. 8C.

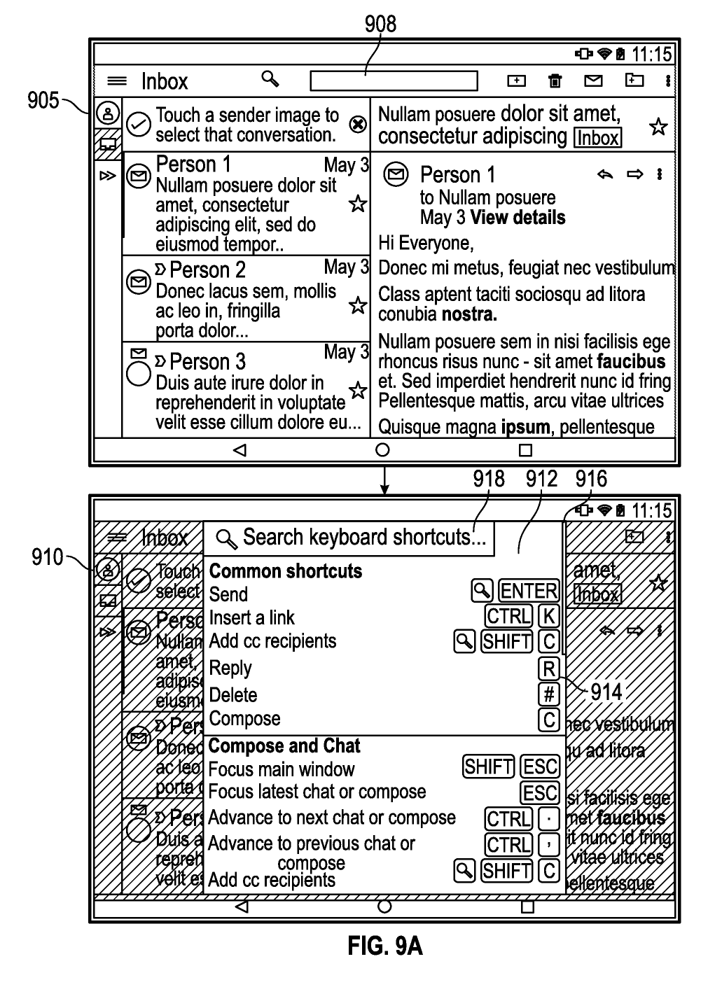

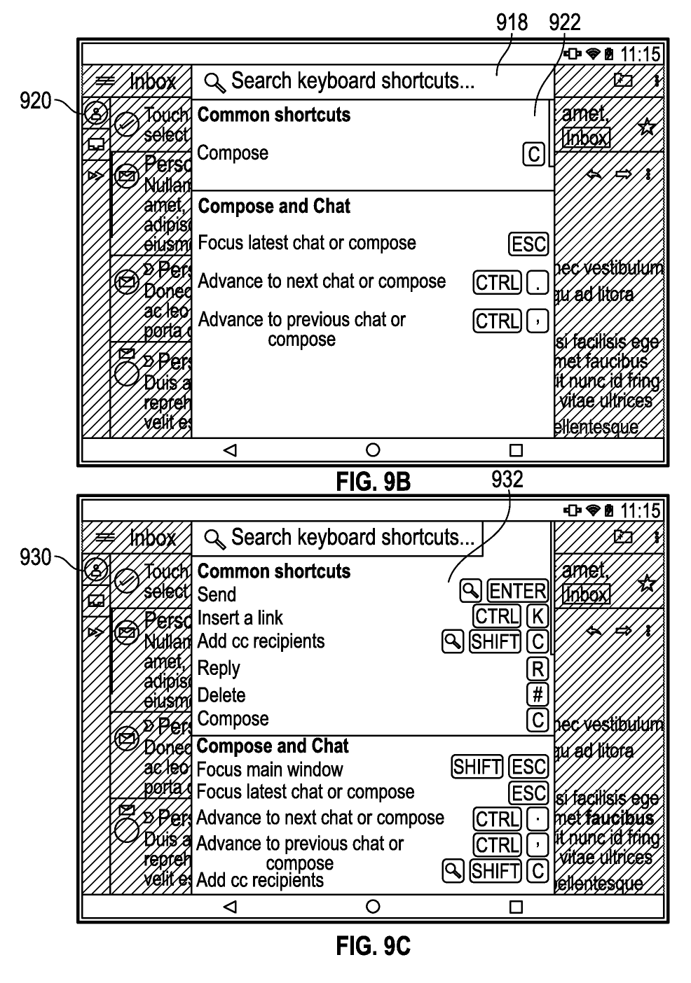

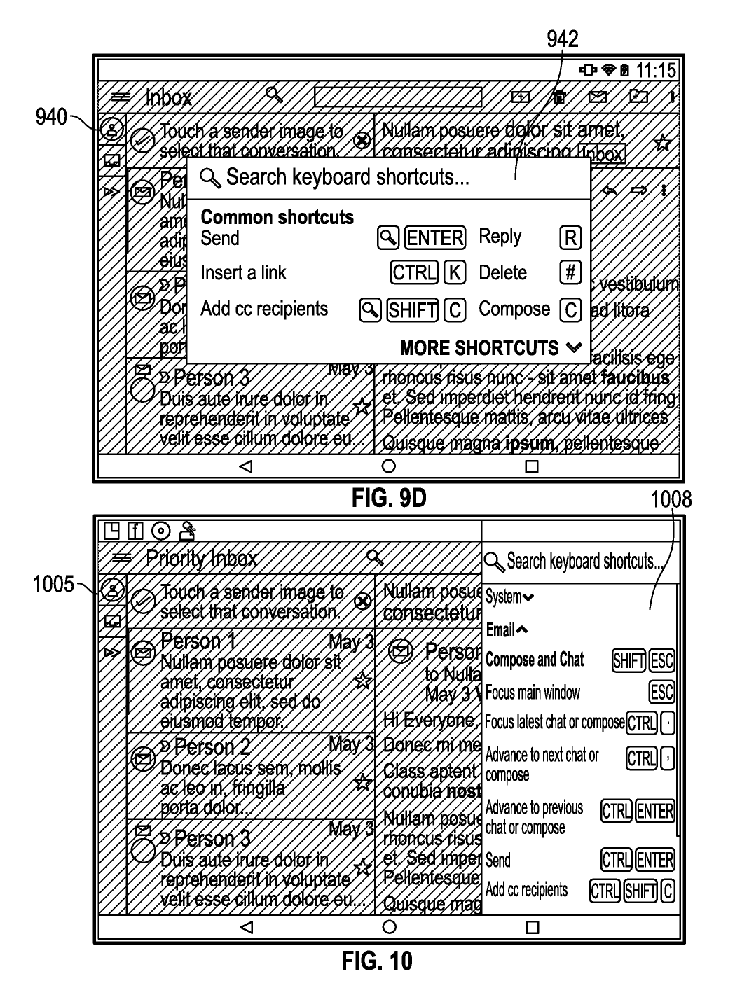

FIG. 9A illustrates an example sequence of user interfaces 905 and 910 for providing shortcut assistance of application level shortcuts, according to example aspects of the subject technology. The user interface 905 includes an email application window associated with an email application launched in the computing device. The email application may have an integrated instant messaging feature. The shortcut assistance may be accessed through a search bar 908 within the email application window (e.g., typing a search term(s) associated with shortcut assistance in the search bar 908), similar in manner to that described with respect to FIG. 8A.

In the user interface 910, a shortcut assistance overlay interface 912 is displayed over the email application window, within which visual representations of application level shortcuts associated with the email application are displayed. An identifier associated with the shortcuts is also displayed in the shortcut assistance overlay interface 912. For the application level shortcuts, the identifier may be a description of an action that is effectuated upon performing the corresponding shortcut. For instance, the shortcut Ctrl+K, when performed, effectuates the action “Insert a link”.

The application level shortcuts may be grouped by the application based on frequency (e.g., expected frequency) of use of the shortcuts and/or actions associated with the shortcuts. In some cases, the shortcuts (e.g., visual representation of shortcuts, identifiers) and/or shortcut groupings to be displayed in the shortcut assistance overlay interface 912, and/or order in which to display the shortcuts and/or shortcut groupings, may be selected by the email application (e.g., creator, author, owner, distributor, etc., of the email application). In some cases, the user may be provided with options that allow the user to adjust (e.g., change, add, remove) the shortcut groupings and/or shortcuts associated with each shortcut grouping.

In the user interface 910, the shortcuts are grouped into “Common” shortcuts and “Compose and Chat” shortcuts. The “Common” shortcuts may include those shortcuts whose actions are determined to be most commonly used by users of the email application. For example, the “Common” shortcuts may be selected by the application (e.g., based on the actions performed and/or shortcuts performed by the user and/or other users that use the application). The “Compose and Chat” shortcuts may include shortcuts whose actions are associated with emails and instant messages transmitted and received via the email application. For example, the action “Advance to next chat or compose” may cause a transition from displaying an instant message to displaying a next instant message (e.g., based on a time stamp) if the user is viewing instant messages, and may cause a transition from displaying an email to displaying a next email (e.g., based on a time stamp) if the user is viewing emails.

The shortcut assistance overlay interface 912 may include a vertical scroll bar 914 and an associated slider 916. The position of the slider 916 indicates which portion of the shortcut assistance overlay interface 912 is being displayed. A user can scroll up and down the shortcut assistance overlay interface 912 via such actions as a touch input, a gesture, a mouse input, etc., on the slider 916 or within the shortcut assistance overlay interface 912. The shortcut assistance overlay interface 912 may include a search bar 918. In some cases, the search bar 918 remains at a predetermined location of the shortcut assistance overlay interface 912 (e.g., even as the shortcuts are being scrolled through). For instance, in the user interface 910, the search bar 918 is at an uppermost part of the shortcut assistance overlay interface 912.

In some aspects, the system level shortcuts are always displayed. For instance, in FIG. 9A, the system level shortcuts may be displayed below all the application level shortcuts. In some cases, if shortcut assistance is launched for an application without associated shortcuts, an shortcut assistance overlay interface may be presented to the user that includes an indication that the application does not have any shortcuts.

In some implementations, the shortcut assistance overlay interface 912 may provide a common interface within which visual representations of shortcuts associated with actions within applications and shortcut groupings may be displayed. In some cases, for a given application, shortcuts (e.g., visual representation of shortcuts, associated identifiers) and/or shortcut groupings to be displayed in the shortcut assistance overlay interface 912, and/or order in which to display the shortcuts and/or shortcut groupings, may be selected by the application (e.g., creator, author, owner, distributor, etc., of the application). A font size and font color of text, size of graphical elements, color of group headings for system shortcuts, color of group headings for application level shortcuts, etc. presented in the shortcut assistance overlay interface 912 may be set for the shortcut assistance overlay interface 912 and independent of the application within which the shortcut assistance is launched.

FIG. 9B illustrates an example user interface 920 for performing a search of shortcuts, according to example aspects of the subject technology. The display device may transition from displaying the user interface 910 of FIG. 9A to displaying the user interface 920 when the search term “Compose” is provided in the search bar 918 of FIG. 9A. The display device may transition from displaying the user interface 910 to displaying the user interface 920 when the user executes (e.g., presses the Enter key) the search using the search term “Compose”. In an aspect, the search results for the word “Compose” may be presented as the word “Compose” is being typed. In this regard, the shortcut assistance overlay interface 912 changes to a shortcut assistance overlay interface 922 that displays search results in response to the search term “Compose”. The search results may include shortcuts associated with the word “Compose” (e.g., all shortcuts whose identifier contains the word “compose” and/or a synonym of “compose”). The search results and their associated group headers are displayed to the user.

In an aspect, the user may type search terms that include keys of a shortcut, and the search results may provide shortcuts that include those keys. For instance, the user may type “ctrl” and/or “control” in the search bar 918, and the search results may display shortcuts that include Ctrl as one of its inputs. Since many shortcuts may utilize the Ctrl button, the search results may display the most commonly used shortcuts that utilize the Ctrl button.

FIG. 9C illustrates an example user interface 930 that includes a button (e.g., DONE button) for closing shortcut assistance, according to example aspects of the subject technology. In some cases, the DONE button may be accessed by scrolling to a bottommost part of the shortcut assistance overlay interface 932. In other cases, the DONE button remains at a predetermined location (e.g., bottommost part) of the shortcut assistance overlay interface 932 (e.g., even as the shortcuts are being scrolled through).

In some implementations, alternative or in addition to using the DONE button, a predetermined user input, when performed, may cause the shortcut assistance overlay interface 932 to close. By way of non-limiting example, the predetermined user input may include tapping/clicking a position on the screen outside of the shortcut assistance overlay interface 932, pressing the Backspace or Esc keys, among others.

FIG. 9D illustrates an example user interface 940 that includes a button (e.g., MORE SHORTCUTS button) for displaying visual representations of more shortcuts, according to example aspects of the subject technology. A shortcut assistance overlay interface 942 may provide the MORE SHORTCUTS button that, when pressed, causes more visual representations of shortcuts to be displayed.

FIG. 10 illustrates an example user interface 1005 for providing shortcut assistance, according to example aspects of the subject technology. Visual representations of shortcuts may be presented in a shortcut assistance overlay interface 1008. In some cases, the shortcut assistance overlay interface 1008 is a side drawer. In an aspect, as shown in FIG. 10, the system level shortcuts and application level shortcuts are provided as part of drop-down lists.

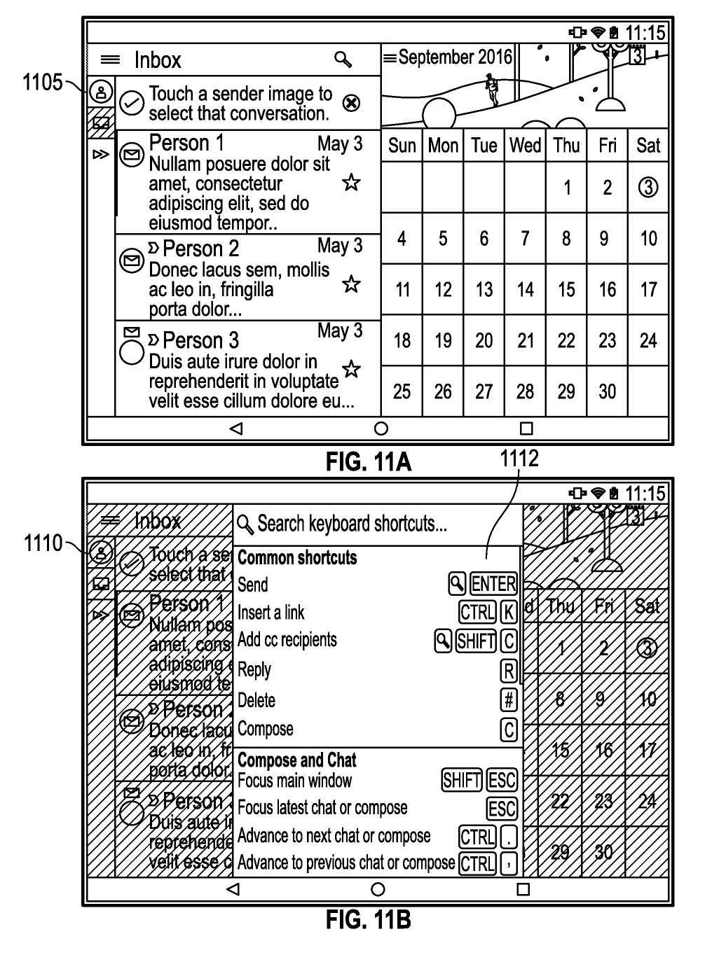

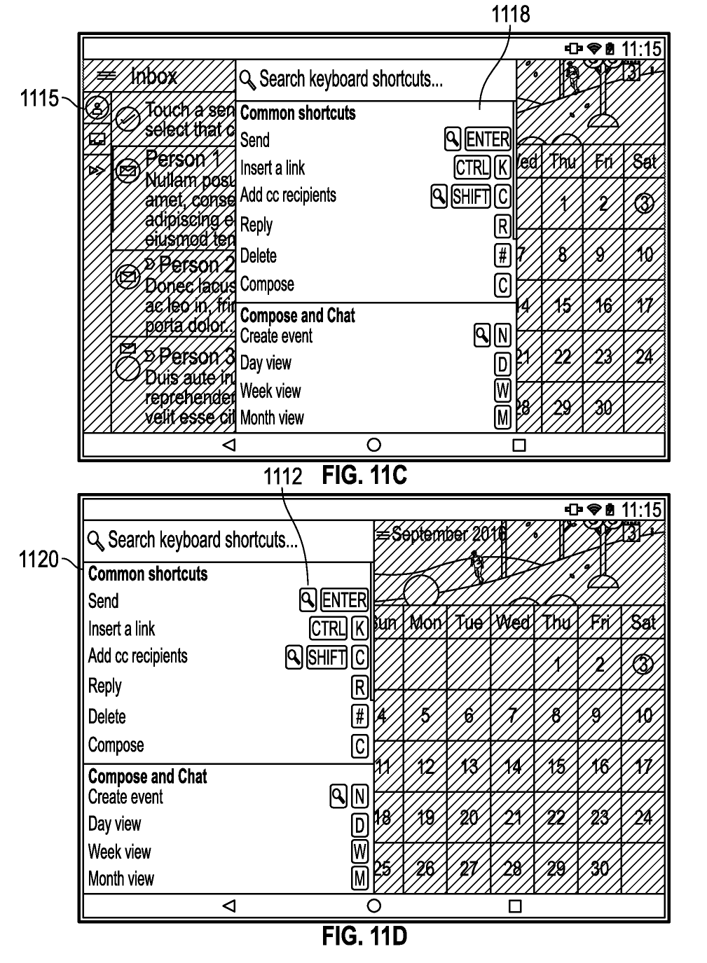

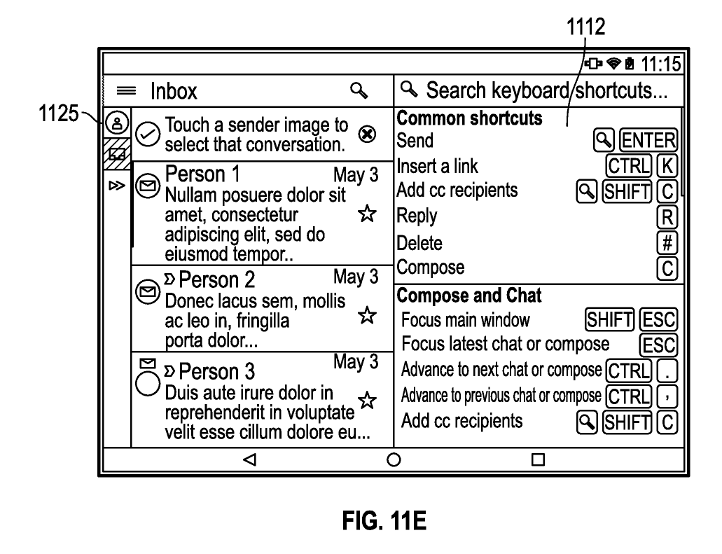

FIG. 11A illustrates an example user interface 1105 including multiple application windows, according to example aspects of the subject technology. The user interface 1105 includes an email application window and a calendar application window presented side by side. The display device may transition from displaying the user interface 1105 to displaying any one of user interfaces 1110, 1115, 1120, and 1125 of FIGS. 11B, 11C, 11D, 11E, respectively (e.g., to access the shortcut assistance). The location of the shortcut assistance overlay interface and the shortcuts indicated in the shortcut assistance overlay interface may be pre-set. In an aspect, the user may subsequently adjust/set the location of the shortcut assistance overlay interface and the shortcuts indicated in the shortcut assistance overlay interface.

FIG. 11B illustrates an example user interface 1110 for displaying shortcuts in a shortcut assistance overlay interface 1112 when multiple application windows are displayed, according to example aspects of the subject technology. The shortcuts indicated within the shortcut assistance overlay interface 1112 include shortcuts associated with the application window associated with the focused application. In FIG. 11B, the email application is the focused application.

FIG. 11C illustrates an example user interface 1115 for displaying shortcuts in a shortcut assistance overlay interface 1118 when multiple application windows are displayed, according to example aspects of the subject technology. The shortcuts indicated within the shortcut assistance overlay interface 1118 include shortcuts for the email application and the calendar application. In some cases, the respective common shortcuts of the email application and the calendar application are presented first in the shortcut assistance overlay interface 1118. In some cases, the predetermined user input for triggering shortcut assistance for shortcuts associated with the focused application may be the same, or may be different, from the predetermined user input for triggering shortcut assistance for shortcuts associated with the non-focused application. In some cases, a different predetermined user input may be defined to cause display of visual representations of shortcuts for the focused application only, non-focused application only, and both the focused and non-focused applications.

FIG. 11D illustrates an example user interface 1120 for displaying shortcuts in the shortcut assistance overlay interface 1112 when multiple application windows are displayed, according to example aspects of the subject technology. The shortcut assistance overlay interface 1112 may include shortcuts for the application that was the focused application (e.g., the email application) when the shortcut assistance was launched. For instance, in FIG. 11D, the shortcut assistance overlay interface 1112 is displayed such that it obscures (e.g., covers) the email application.

FIG. 11E illustrates an example user interface 1125 for displaying shortcuts in the shortcut assistance overlay interface 1112 when multiple application windows are displayed, according to example aspects of the subject technology. The shortcut assistance overlay interface 1112 includes shortcuts for the application that was the focused application (e.g., the email application) when the shortcut assistance was launched. For instance, in FIG. 11E, the shortcut assistance overlay interface 1112 is presented such that it is next to the application window of the email application (e.g., obscures the application window of the non-focused application). In some cases, the email application remains focused even when the shortcut assistance overlay interface 1112 is displayed.

FIG. 12 conceptually illustrates an example electronic system 1200 with which some implementations of the subject technology can be implemented. Electronic system 1200 can be a computer, phone, personal digital assistant (PDA), or any other sort of electronic device. Such an electronic system includes various types of computer readable media and interfaces for various other types of computer readable media. Electronic system 1200 includes a bus 1208, processing unit(s) 1212, a system memory 1204, a read-only memory (ROM) 1210, a permanent storage device 1202, an input device interface 1214, an output device interface 1206, and a network interface 1216.

Bus 1208 collectively represents all system, peripheral, and chipset buses that communicatively connect the numerous internal devices of electronic system 1200. For instance, bus 1208 communicatively connects processing unit(s) 1212 with ROM 1210, system memory 1204, and permanent storage device 1202.

From these various memory units, processing unit(s) 1212 retrieves instructions to execute and data to process in order to execute the processes of the subject disclosure. The processing unit(s) can be a single processor or a multi-core processor in different implementations.

ROM 1210 stores static data and instructions that are needed by processing unit(s) 1212 and other modules of the electronic system. Permanent storage device 1202, on the other hand, is a read-and-write memory device. This device is a non-volatile memory unit that stores instructions and data even when electronic system 1200 is off. Some implementations of the subject disclosure use a mass-storage device (for example, a magnetic or optical disk and its corresponding disk drive) as permanent storage device 1202.

Other implementations use a removable storage device (for example, a floppy disk, flash drive, and its corresponding disk drive) as permanent storage device 1202. Like permanent storage device 1202, system memory 1204 is a read-and-write memory device. However, unlike storage device 1202, system memory 1204 is a volatile read-and-write memory, such as a random access memory. System memory 1204 stores some of the instructions and data that the processor needs at runtime. In some implementations, the processes of the subject disclosure are stored in system memory 1204, permanent storage device 1202, or ROM 1210. For example, the various memory units include instructions for displaying graphical elements and identifiers associated with respective applications, receiving a predetermined user input to display visual representations of shortcuts associated with respective applications, and displaying the visual representations of shortcuts. From these various memory units, processing unit(s) 1212 retrieves instructions to execute and data to process in order to execute the processes of some implementations.

Bus 1208 also connects to input and output device interfaces 1214 and 1206. Input device interface 1214 enables the user to communicate information and select commands to the electronic system. Input devices used with input device interface 1214 include, for example, alphanumeric keyboards and pointing devices (also called “cursor control devices”). Output device interfaces 1206 enables, for example, the display of images generated by the electronic system 1200. Output devices used with output device interface 1206 include, for example, printers and display devices, for example, cathode ray tubes (CRT) or liquid crystal displays (LCD). Some implementations include devices, for example, a touchscreen that functions as both input and output devices.

Finally, as shown in FIG. 12, bus 1208 also couples electronic system 1200 to a network (not shown) through a network interface 1216. In this manner, the computer can be a part of a network of computers (for example, a LAN, a WAN, or an Intranet, or a network of networks, for example, the Internet). Any or all components of electronic system 1200 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage, and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A computer-implemented method, comprising:
displaying, on a display device, one or more graphical elements and one or more associated identifiers, wherein each of the one or more graphical elements is associated with a respective application;
receiving a predetermined user input to display visual representations of shortcuts on the display device; and
in response to receiving the predetermined user input, displaying, on the display device, a visual representation of a respective shortcut for each respective application, wherein the respective shortcut, when performed, causes launching of the respective application.

2. The method of claim 1, further comprising:
receiving a first user input;
determining that the first user input matches a shortcut corresponding to a respective application; and
launching, in a client device, the respective application in response to the determining.

3. The method of claim 1, wherein displaying the visual representation of the respective shortcut comprises replacing, on the display device, the respective identifier with the visual representation of the respective shortcut for each respective application.

4. The method of claim 3, wherein the respective identifier comprises an application name of the respective application.

5. The method of claim 1, wherein displaying the visual representation of the respective shortcut comprises displaying the visual representation of the respective shortcut together with the respective identifier for each respective application.

6. The method of claim 5, wherein a portion of the respective identifier is obscured by the visual representation of the respective shortcut for each respective application.

7. The method of claim 1, wherein the predetermined user input comprises one or more keyboard inputs.

8. A computing system, comprising:
one or more processors; and
a non-transitory machine-readable medium comprising instructions stored therein, which when executed by the one or more processors, cause the one or more processors to perform operations comprising:
receiving a first user input to display visual representations of shortcuts;
in response to receiving the first user input, displaying a visual representation of a shortcut for a first application; and
launching the first application when the shortcut for the first application is performed.

9. The computing system of claim 8, wherein the operations further comprise:
receiving a second user input;
determining that the second user input matches a shortcut for a second application; and
launching the second application based on determining that the second user input matches the shortcut for the second application.

10. The computing system of claim 8, wherein displaying the visual representation further comprises displaying a respective visual representation for each of a plurality of shortcuts, wherein each respective visual representation is associated with a respective application.

11. The computing system of claim 8, wherein the operations further comprise:
displaying a graphical element and an associated identifier, wherein the graphical element is associated with the first application, and wherein the visual representation obscures a portion of at least one of the graphical element or the associated identifier.

12. The computing system of claim 8, wherein displaying the visual representation of the respective shortcut comprises replacing a displayed identifier associated with the first application with the visual representation of the shortcut for the first application.

13. The computing system of claim 12, wherein the displayed identifier comprises an application name of the first application.

14. The computing system of claim 8, wherein the first user input comprises one or more keyboard inputs from a physical keyboard communicatively connected to the computing system.

15. A non-transitory machine-readable medium comprising instructions stored therein, which when executed by a machine, cause the machine to perform operations comprising:
displaying, on a display device, a graphical element and an associated identifier, wherein the graphical element is associated with an application;
receiving a first user input to display visual representations of shortcuts on the display device; and
in response to receiving the first user input, displaying, on the display device, a visual representation of a shortcut associated with the application, wherein the visual representation obscures at least one of the graphical element or the associated identifier, and wherein the shortcut, when performed, causes launching of the application.

16. The non-transitory machine-readable medium of claim 15, wherein the operations further comprise:
receiving a second user input; and
launching, in a client device, the application when the second user input matches the shortcut for the application.

17. The non-transitory machine-readable medium of claim 15, wherein displaying the visual representation of the shortcut comprises replacing, on the display device, the associated identifier with the visual representation of the shortcut for the application.

18. The non-transitory machine-readable medium of claim 17, wherein the identifier comprises an application name of the application.

19. The non-transitory machine-readable medium of claim 15, wherein displaying the visual representation further comprises displaying a respective visual representation for each of a plurality of shortcuts, wherein each respective visual representation is associated with a respective application.

20. The non-transitory machine-readable medium of claim 15, wherein the display device comprises a touchscreen, and wherein the first user input comprises a gesture performed on the touchscreen.
